(19) United States
(12) Patent Application Publication
(10) Pub. No.: US 2005/0120086 A1
(43) Pub. Date: Jun. 2, 2005

(54) Method and apparatus for selectively fetching e-mail

(75) Inventor: Young-Hoon Kim, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/996,067

(22) Filed: Nov. 24, 2004

(30) Foreign Application Priority Data
Nov. 29, 2003 (KR) 10-2003-0086050

(51) Int. Cl. G06F 15/16

(52) U.S. Cl. 709/206

(57) ABSTRACT

A method and apparatus to selectively fetch and print e-mails which are received by a mail server via a network during a time period specified by a user. The method allows a user to specify the time period for which received e-mails are desired, than to access the mail server and sequentially fetch and evaluate the e-mail header sections stored in the mail server. The user can then selectively fetch the e-mails received in the mail sever during the specified time period based upon the evaluation of the sequentially-fetched e-mail header sections, and print or store the fetched e-mail results.

### CROSS-REFERENCE TO RELATED APPLICATIONS

This application claims the benefit under 35 U.S.C. §119(a) of Korean Patent Application No. 2003-86050, filed in the Korean Intellectual Property Office on Nov. 29, 2003, the entire contents of which are incorporated herein by reference.

### BACKGROUND OF THE INVENTION

1. Field of the Invention

The present invention relates to a method and apparatus for receiving e-mails. More particularly, the present invention relates to a method and apparatus for selectively fetching and printing e-mails which are received by a mail server via a network during a time period specified by a user.

2. Description of the Related Art

FIG. 1 is a view illustrating a system for transmitting and/or receiving facsimiles or e-mails by using a network, such as the Internet or a public switched telephone network (PSTN). The system comprises an internet fax machine 100, a G3 fax machine 110, a simple mail transfer protocol (SMTP) server 120 and 150, a post office protocol 3 (POP3) server 130 and 160, the Internet 140, and an e-mail user 180.

An e-mail fetching procedure of the Internet fax machine 100 will now be described in greater detail.

When the e-mail user 180 sends the e-mails to the Internet fax machine 100, the e-mails are temporarily stored in the SMTP server 150. The e-mails stored the SMTP server 150 are transmitted to and stored in the receiver-side POP3 server 130 through the Internet 140. The internet fax machine 100 is connected to the receiver-side POP3 server 130 to fetch the e-mails stored in the receiver-side POP3 server 130. In this case, the internet fax machine 100 fetches the e-mails stored in the POP3 server 130 in sequential order only, that is, fetching the next e-mail after the last fetching is performed by the internet fax machine 100.

The e-mails fetched from the POP3 server 130 are directly printed or stored. In some cases, the e-mails fetched from the POP server 130 may be erased in accordance with selected options in the internet fax machine 100.

In a conventional approach, the internet fax machine 100 retrieves header sections of the e-mails in order to fetch the e-mail stored in a mail server, that is, the POP3 server 130. Arrival time, that is, a time when the e-mail is received by the POP3 server 130 is recorded in the header section of the e-mail.

By comparing the arrival times recorded in the header sections of the previously fetched e-mails with the arrival times recorded in the header sections of the e-mails stored in the POP3 server 130, the internet fax machine 100 fetches the e-mails stored in the POP3 server 130 in sequential order only, that is, fetching the next e-mail after the last fetching is performed by the internet fax machine 100.

In this conventional approach, there is a problem in that, when a user loses a previously fetched e-mail, the user cannot fetch the lost e-mail from the POP3 server 130. Additionally, there is no means to fetch e-mails in a non-sequential order, such as fetching e-mails received during a specific period. Prior solutions have attempted to provide systems which can fetch e-mails received from a specific sender. For example, an internet fax machine fetching only the e-mails received by a user-specified client out of e-mails stored in a mail server connected to a local area network (LAN), is disclosed in Korean Patent Application No. 2000-0073172, the entire content of which is incorporated herein by reference. However, the above device does not solve the above problems in that it fetches all e-mails from a user-specified client server.

Accordingly, a need exists for a system and method for selectively fetching and printing e-mails which are received during a time period specified by a user.

### SUMMARY OF THE INVENTION

The present invention solves the above and other problems by providing a method and apparatus for selectively fetching and printing e-mails which are received by a mail server via a network during a time period specified by a user.

According to an object of the present invention, an apparatus is provided for selectively fetching and printing e-mails received by a mail server connected with a network during a time period specified by a user. The apparatus comprises an e-mail fetching unit which sequentially fetches the e-mails received by the mail server, an operating panel used to input the time period, a control unit which extracts header sections of the e-mails and allows the e-mail fetching unit to select the e-mails received by the mail server during the specified time period, and a printing unit which prints the e-mails fetched by the e-mail fetching unit.

The apparatus can further comprise a storage unit which stores the fetched e-mails.

In the apparatus, the control unit can extract header sections of the e-mails, determine whether or not each of the e-mails was received by the mail server during the specified time period, and if the e-mail was received during the specified time period, allow the e-mail fetching unit to fetch the e-mail, and if not, then direct the e-mail fetching unit to not fetch the e-mail.

In the apparatus, the specified time period can be specified by any suitable parameter, such as date or time.

According to another object of the present invention, a method is provided for selectively fetching and printing e-mails received by a mail server connected with a network during a time period specified by a user, the method comprising (a) specifying the time period, (b) accessing the mail server, (c) sequentially fetching the e-mails stored in the mail server, (d) selectively fetching the e-mails received in the mail sever during the specified time period from the sequentially-fetched e-mails, and (e) printing the fetched e-mails.

In the method, the specified time period can also be specified by any suitable parameter, such as date or time.

In the method, the step (b) can be a step for manually accessing the mail server by the user's operation or a step for automatically accessing the mail sever in accordance with a user's specified accessing period.

In the method, the step (d) can further comprise steps (aa) for extracting header sections of the e-mails, (bb) for determining whether or not each of the e-mail is received by the mail server during the specified time period, and (cc) for fetching the e-mail if the e-mail is received during the specified time period, and if not, then not fetching the e-mail and moving to the next e-mail.

In the method, the step (d) can further comprise a step for storing the e-mails in a storage unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram for explaining an internet fax machine fetching e-mails through a conventional network;

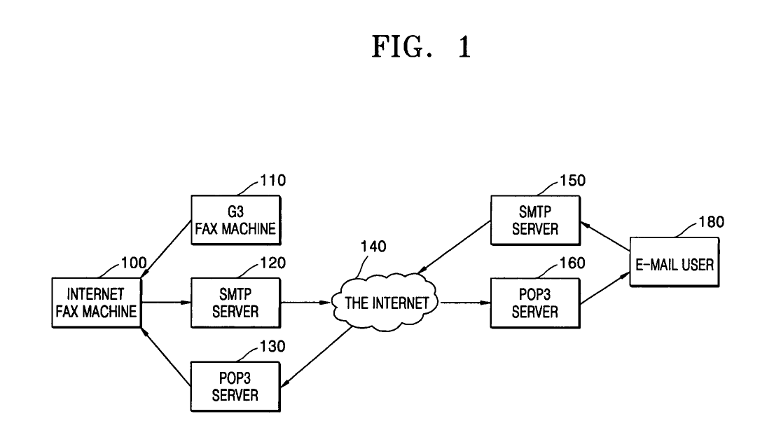

FIG. 2 is a block diagram illustrating a device, such as an internet fax machine, for selectively fetching e-mails according to an embodiment of the present invention;

FIG. 3 is a flowchart for explaining a step for specifying a time period according to an embodiment of the present invention; and

FIG. 4 is a flowchart for explaining a method for selectively fetching e-mails stored in a POP3 server in a time period specified by a user.

Throughout the drawings, like reference numerals will be understood to refer to like parts, components and structures.

### DETAILED DESCRIPTION OF THE EXEMPLARY EMBODIMENTS

The present invention and operational advantages thereof can be fully understood by referring to the accompanying drawings and explanations thereof.

Exemplary embodiments of the present invention will now be described with reference to the accompanying drawings to explain the present invention in detail.

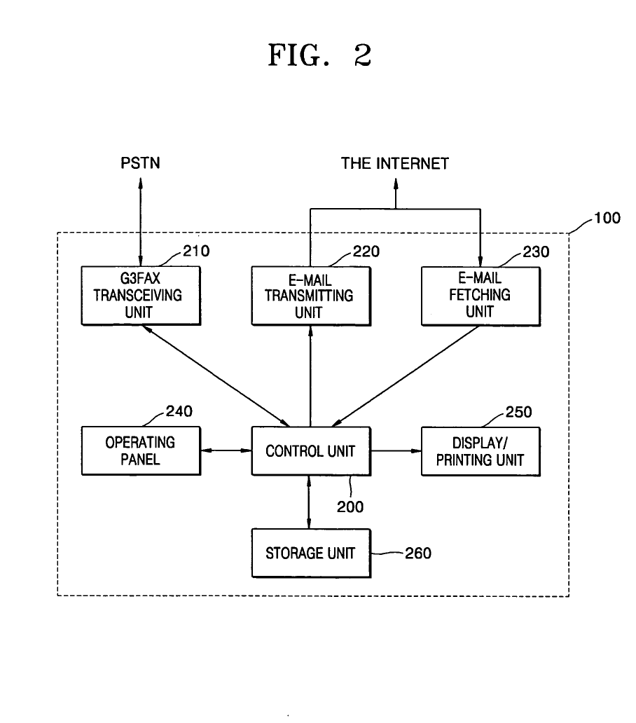

FIG. 2 is a block diagram illustrating a device, such as an internet fax machine 100, for selectively fetching e-mails according to an embodiment of the present invention. The internet fax machine 100 comprises a control unit 200, a G3 fax transceiver unit 210, an e-mail transmitting unit 220, an e-mail fetching unit 230, an operating panel 240, a display/printing unit 250, and a storage unit 260.

The control unit 200 controls the components of the internet fax machine 100 to carry out the following operations in order to selectively fetch e-mails received by a mail server (not shown). Firstly, header sections of e-mails received by the e-mail fetching unit 230 are extracted. Arrival times recorded in the header sections of the e-mails are then checked to determine if they correspond to a predetermined receiving time period. If the arrival time of an e-mail corresponds to the specified time period, the e-mail is fetched. If not, the e-mail is not fetched and the arrival time of the next e-mail is checked.

The G3 fax transceiver unit 210 has a G3 fax transceiving function, which is a general facsimile function carried out through a public switched telephone network (PSTN).

The e-mail transmitting unit 220 of the internet fax machine 100 converts an e-mail into a predetermined format in order to transmit the e-mail to a particular user through the Internet.

In response to a command from the control unit 200, the e-mail fetching unit 230 then connects with and logs-in to the mail server and fetches the e-mails corresponding to the specified time period.

More specifically, in response to an e-mail fetching command from the control unit 200, the e-mail fetching unit 230 connects with the mail server and logs-in to the mail server by inputting ID and password information.

After this step, the e-mail fetching unit 230 then sequentially fetches the e-mails stored in the mail server. The e-mails stored in the mail server include header sections where e-mail information is recorded. The e-mail information recorded in the header section of an e-mail includes an e-mail transmitting path, addresses of a sender and a receiver, and an arrival time of the e-mail.

The control unit 200 then extracts header sections of the e-mails and determines whether or not the arrival time recorded in the header sections of the e-mails corresponds to the predetermined receiving time period. More preferably, the user can input the receiving time period of the mail server by using the operating panel 240.

If the arrival time of the e-mail corresponds to the specified time period, the control unit 200 allows the e-mail fetching unit 230 to fetch the e-mail.

If not, the control unit 200 commands the e-mail fetching unit 230 to not fetch the e-mail and the foregoing procedure is repeated in order to fetch the next e-mail stored in the mail server.

Although the e-mail fetching is performed based on the specified time period, the user can directly connect with the mail server and fetch e-mails from the mail sever at any arbitrary time.

The display/printing unit 250 converts the e-mail fetched by the e-mail fetching unit 230 into a printable format, and prints the e-mail on a paper. The printing unit 250 can be implemented in any number of ways known to those skilled in the art. As such, a detailed description of the printing unit 250 is omitted.

The operating panel 240 comprises a plurality of key buttons used to input the specified time period by the user. In addition, the operating panel 240 further comprises a liquid crystal display (LCD) for displaying contents of the fetched e-mail.

The storage unit 260 temporarily stores the e-mails fetched by the e-mail fetching unit 230 and can function as a buffer for the printing unit 250.

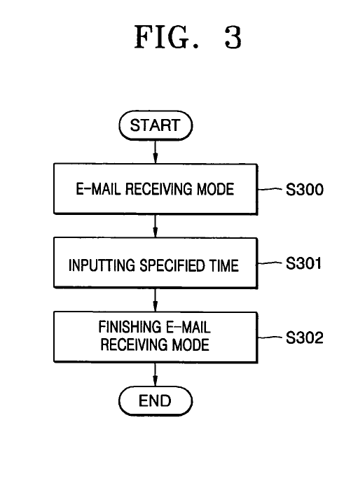

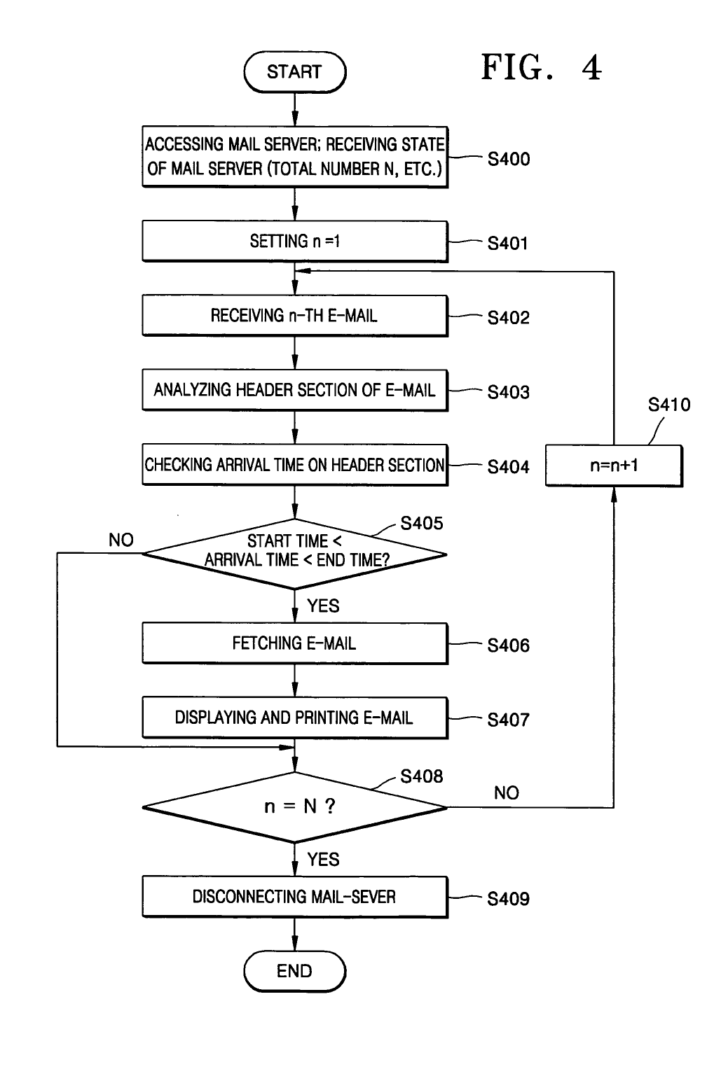

FIG. 3 is a flowchart for explaining a step for specifying a time period according to an embodiment of the present invention. FIG. 4 is a flowchart for explaining a method for then selectively fetching e-mails stored in a POP3 server for a time period specified by a user.

Table 1 shows examples of 10 e-mails received and stored in the mail server, which are to be fetched by the internet fax machine 100 in accordance with an embodiment of the present invention. In this example, it is assumed that the user desires to fetch the e-mails received and stored in the mail server for a time period from 13:00 hours on Sep. 25, 2003, to 16:00 hours on Sep. 27, 2003.

TABLE 1

| No. | Name | Sender | Receiver | Arrival Time |
|---|---|---|---|---|
| 1 | 1st Mail | aaa@samsung.com | rcpt@samsung.com | 2003.9.25.08:00 |
| 2 | 2nd Mail | bbb@samsung.com | rcpt@samsung.com | 2003.9.25.13:00 |
| 3 | 3rd Mail | ccc@samsung.com | rcpt@samsung.com | 2003.9.25.19:00 |
| 4 | 4th Mail | ddd@samsung.com | rcpt@samsung.com | 2003.9.26.08:00 |
| 5 | 5th Mail | eee@samsung.com | rcpt@samsung.com | 2003.9.26.14:30 |
| 6 | 6th Mail | fff@samsung.com | rcpt@samsung.com | 2003.9.26.22:00 |
| 7 | 7th Mail | ggg@samsung.com | rcpt@samsung.com | 2003.9.27.17:05 |
| 8 | 8th Mail | iii@samsung.com | rcpt@samsung.com | 2003.9.27.11:40 |
| 9 | 9th Mail | jjj@samsung.com | rcpt@samsung.com | 2003.9.27.14:50 |
| 10 | 10th Mail | hhh@samsung.com | rcpt@samsung.com | 2003.9.27.17:00 |

Referring to FIG. 3, the user first selects an e-mail fetching mode displayed on the liquid crystal display (LCD) screen of the operating panel 240 at step S300.

Using the keys on the operating panel 240, the user inputs a specified time period, used by the apparatus to fetch e-mails which are received by the mail server during the specified time period, at step S301. As described above, in the embodiment of the present invention, the specified time period example is from 13:00 hours on Sep. 25, 2003, to 16:00 hours on Sep. 27, 2003.

Next, after inputting the specified time period, the user pushes a button for finishing the e-mail fetching mode at step S302.

In an alternative embodiment, an e-mail fetching mode button and an e-mail fetching mode finishing button can be provided on the operating panel 240. In still another alternative embodiment, the operations of selecting the e-mail fetching mode, inputting the specified time period, and finishing the e-mail fetching mode, etc., can be implemented with a touch screen on the display unit of the operating panel 240.

The method for selectively fetching e-mails which are received by the mail server during the user-specified time period will now be described in greater detail with reference to FIG. 4 and Table 1.

Firstly, in the example shown in Table 1 and FIG. 4, the user has access to the mail-server 130 through the Internet 140, and can log-in to the mail server 130 with predetermined information, for example, ID, password, etc. Next, the state of e-mails received by the mail sever 130 is transferred to the e-mail fetching unit 230 at step S400. The state of e-mails includes information such as the total number (N) of e-mails received and stored in the mail server, total size of the stored e-mails, etc.

Next, the number of e-mails received and stored in the mail server 130 is counted. In order to count the number of e-mails which will be fetched, the initial count number is set to 1 at step S401.

An e-mail corresponding to n=1 is then fetched from the mail server 130 to the e-mail fetching unit 230 at step S402. Referring to the example set of Table 1, as to the e-mail corresponding to n=1, the sender's e-mail address is aaa@samsung.com, the receiver's e-mail address is rcpt@samsung.com, and the arrival time is 8:00 hours on Sep. 25, 2003.

The header section of the e-mail (n=1) is then transferred, and the control unit 200 analyzes the header section of the e-mail (n=1) at step S403.

The control unit 200 reads the arrival time of the e-mail from its header section at step S404.

It is then determined whether or not the arrival time of the e-mail (n=1) corresponds to the user-specified time period from 13:00 hours on Sep. 25, 2003, to 16:00 hours on Sep. 27, 2003 at step S405.

Since the arrival time of the e-mail (n=1) is 8:00 hours on Sep. 25, 2003, the e-mail is determined to have not been received during the user-specified time period. Therefore, the e-mail (n=1) is not fetched to the e-mail fetching unit 230 and the method jumps to step S408. At step 408, it is determined if there are remaining e-mails. Next, in order to analyze the next e-mail (n=2), the count value n is increased by 1 at step S410, and steps S402 through S408 are repeated.

The header section of the e-mail (n=2) is then transferred at step S402. Referring to Table 1, as to the e-mail corresponding to n=2, the sender's e-mail address is bbb@samsung.com, the receiver's e-mail address is rcpt@samsung.com, and the arrival time is 13:00 hours on Sep. 25, 2003. Since the arrival time of the e-mail (n=2) does not correspond to the user-specified time period from 13:00 hours on Sep. 25, 2003, to 16:00 hours on Sep. 27, 2003, the e-mail (n=2) is not fetched and the header section of the next e-mail (n=3) is transferred.

Referring to Table 1, since the arrival time of the e-mails (n=1˜4) do not correspond to the user-specified time period, the e-mails (n=1˜4) are not fetched and only their header sections are transferred.

As to the e-mail corresponding to n=5, the sender's e-mail address is eee@samsung.com, the receiver's e-mail address is rcpt@samsung.com, and the arrival time is 14:30 hours on Sep. 26, 2003.

Since the arrival time of the e-mail (n=5) does correspond to the user-specified time period, detected at step S405, the control unit 200 directs the e-mail fetching unit 230 to fetch the e-mail (n=5) at step S406.

The fetched e-mails can be printed to the printing unit 250 at the time of fetching by the user's request. Alternatively, the fetched e-mails can be temporarily stored in the storage unit 260. When the user desires to view the e-mails, the user can display the e-mails on the LCD screen (not shown) of the operating 240 by clicking the desired e-mails on the e-mail list displayed.

In accordance with the embodiment of the present invention implemented with the example data of Table 1, the e-mails (n=5˜9) are fetched.

In the embodiment, although the time period is specified with date, hour, minute, and second, the time period can be alternatively specified with only the date by the user. In this case, only the dates of the e-mails are analyzed in step S404.

The following Table 2 shows various types of the specified time periods which are possible, and which can be checked in step S404. The list of Table 2 is presented as an example, and is not intended to limit the scope of the invention.

TABLE 2

| | |
|---|---|
| Start Date˜End Date | Fetching e-mails arriving at the mail server |
| | between start date and end date. |
| Start Date˜Open | Fetching e-mails arriving at the mail server |
| | after start date. |
| Open˜End Date | Fetching e-mails arriving at the mail server |
| | before end date. |
| Start Time˜End Time | Fetching e-mails arriving at the mail server |
| | between start time and end time. |
| Open˜End Time | Fetching e-mails arriving at the mail server |
| | before end time. |
| Start Time˜Open | Fetching e-mails arriving at the mail server |
| | after start time. |

According to the embodiments of the present invention, only the e-mails received and stored during a user's specified time period are selectively fetched and printed.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. An apparatus for selectively fetching and printing e-mails received by a mail server connected with a network during a time period specified by a user, the apparatus comprising:
an e-mail fetching unit, which selectively fetches the e-mails received by the mail server;
an operating panel, used to input the time period specified by the user;
a control unit, which extracts header sections of the e-mails and allows the e-mail fetching unit to selectively fetch the e-mails received by the mail server during the specified time period; and
a printing unit, which prints the e-mails fetched by the e-mail fetching unit.

2. The apparatus according to claim 1, further comprising a storage unit which stores the fetched e-mails.

3. The apparatus according to claim 1, wherein the control unit comprises:
a decision function to extract header sections of the e-mails, determine whether or not each of the e-mails is received by the mail server during the specified time period, and allow the e-mail fetching unit to fetch the e-mail if the e-mail is received during the specified time period, and if not, then prevent the e-mail fetching unit from fetching the e-mail.

4. The apparatus according to claim 1, wherein the specified time period is specified by at least one of a date, hour, minute or second.

5. A method of selectively fetching and printing e-mails received by a mail server connected with a network during a time period specified by a user, the method comprising:
(a) specifying the time period;
(b) accessing the mail server;
(c) sequentially fetching header sections of the e-mails stored in the mail server;
(d) selectively fetching the e-mails received in the mail sever during the specified time period based upon the sequentially-fetched e-mail header sections; and
(e) printing the fetched e-mails.

6. The method according to claim 5, wherein the specified time period is specified by at least one of a date, hour, minute or second.

7. The method according to claim 5, wherein the step (b) further comprises the step of:
manually accessing the mail server via a user's operation in accordance with a user's specified accessing period.

8. The method according to claim 5, wherein the step (b) further comprises the step of:
automatically accessing the mail sever in accordance with a user's specified accessing period.

9. The method according to claim 5, wherein the step (d) further comprises the steps of:
(aa) extracting the header section of the e-mail;
(bb) determining whether or not the e-mail was received by the mail server during the specified time period;
(cc) fetching the e-mail if the e-mail was received during the specified time period, and if not, then not fetching the e-mail; and
(dd) repeating steps (aa) through (cc) for a next e-mail.

10. The method according to claim 9, wherein the step (d) further comprises a step of storing the fetched e-mails.

11. The apparatus according to claim 2, wherein the control unit comprises:
a decision function to extract header sections of the e-mails, determine whether or not each of the e-mails is received by the mail server during the specified time period, and allow the e-mail fetching unit to fetch the e-mail if the e-mail is received during the specified time period, and if not, then prevent the e-mail fetching unit from fetching the e-mail.
